(19) United States
(12) Patent Application Publication
(10) Pub. No.: US 2023/0081453 A1
(43) Pub. Date: Mar. 16, 2023

(54) LIGHT SOURCE DRIVING CIRCUIT AND LIGHT SOURCE DRIVING METHOD OF DISPLAY PANEL

(71) Applicant: TCL CHINA STAR OPTOELECTRONICS TECHNOLOGY CO., LTD., Shenzhen, Guangdong (CN)

(72) Inventor: Jinfeng Liu, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/614,503

(22) PCT Filed: Oct. 26, 2021
(86) PCT No.: PCT/CN2021/126407

§ 371 Date: Nov. 26, 2021

(30) Foreign Application Priority Data
Sep. 14, 2021 (CN) 202111074955.8

(51) Int. Cl. G09G 3/34; G09G 3/36

(52) U.S. Cl. CPC G09G 3/3406; G09G 3/36; G09G 2320/0233; G09G 2330/021

(57) ABSTRACT

A light source driving circuit and a light source driving method of a display panel are provided. The light source driving method of a display panel includes: acquiring a load value for displaying a frame of an image, wherein the load value is a predetermined current value for driving a light emitting diode array of the display panel; determining whether the load value is greater than a first threshold, wherein the first threshold is 20% of a rated current of the light emitting diode array; controlling the light emitting diode array to be turned on and off based on one of a pulse width modulation signal, a pulse frequency modulation signal, and a pulse skipping modulation signal according to a determining result, such that an average current input to the light emitting diode array is the predetermined current value.

### FIELD OF DISCLOSURE

The present disclosure relates to the field of display technologies, in particular to a light source driving circuit and a light source driving method of a display panel.

### BACKGROUND

With the advancement of semiconductor technologies, a luminous brightness and a luminous efficiency of light emitting diodes (LEDs) continue to increase. Application fields of the light emitting diodes are very wide, such as lighting devices, liquid crystal displays (LCDs), and backlights.

In the liquid crystal display, a driving device for driving the light emitting diodes usually adopts a direct current circuit. The direct current circuit includes a boost circuit, a buck circuit, or a combination of the two. The existing driving device is based on a pulse width modulation (PWM) structure. However, in a case of light load, the use of the PWM mode will significantly reduce an efficiency of the direct current circuit, which in turn causes the circuit to consume more power.

Accordingly, it is necessary to provides a light source driving circuit and a light source driving method of a display panel to solve the problems existing in the prior art.

### SUMMARY OF DISCLOSURE

In order to solve the above-mentioned problems in the prior art, a purpose of the present disclosure is to provide a light source driving circuit and a light source driving method of a display panel, which can improve a large power consumption of the light source driving circuit of the display panel.

To achieve the above purpose, the present disclosure provides a light source driving method of a display panel, including: acquiring a load value for displaying a frame of an image, wherein the load value is a predetermined current value for driving a light emitting diode array of the display panel; determining whether the load value is greater than a first threshold; controlling the light emitting diode array to be turned on and off based on a pulse width modulation signal if the load value is greater than the first threshold, such that an average current input to the light emitting diode array is the predetermined current value; and controlling the light emitting diode array to be turned on and off based on a pulse frequency modulation signal or a pulse skipping modulation signal if the load value is less than the first threshold, such that the average current input to the light emitting diode array is the predetermined current value. The light source driving method further comprises: acquiring a first set value corresponding to an output ripple, and determining whether the first set value is within a range of a second threshold if the load value is less than the first threshold value, wherein if the first set value is within the range of the second threshold, the light emitting diode array is controlled to be turned on and off based on the pulse skipping modulation signal, and if the first set value is outside the range of the second threshold, the light emitting diode array is controlled to be turned on and off based on the pulse frequency modulation signal; or acquiring a second set value corresponding to a voltage precision, and determining whether the second set value is within a range of a third threshold if the load value is less than the first threshold, wherein if the second set value is within the range of the third threshold, the light emitting diode array is controlled to be turned on and off based on the pulse frequency modulation signal, and if the second set value is outside the range of the third threshold, the light emitting diode array is controlled to be turned on and off based on the pulse skipping modulation signal.

In some embodiment, the display panel comprises a first switch, a second switch, a third switch, and a first detection module, the first switch is disposed in an output path of the pulse width modulation signal, the second switch is disposed in an output path of the pulse frequency modulation signal, the third switch is disposed in an output path of the pulse skipping modulation signal, and the first detection module is configured to acquire the load value and determine whether the load value is greater than the first threshold; if the predetermined current value is greater than the first threshold, the first detection module outputs a logic control signal “1” to control the first switch to turn on, and to control the second switch and the third switch to turn off; and if the predetermined current value is less than the first threshold, the first detection module outputs a logic control signal “0” to control the first switch to turn off, and to control the second switch and the third switch to turn on.

In some embodiment, the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the first set value is within the range of the second threshold; if the first set value is within the range of the second threshold, the second detection module outputs a logic control signal “1” to control the fifth switch to turn on, and to control the fourth switch to turn off; and if the first set value is outside the range of the second threshold, the second detection module outputs a logic control signal “0” to control the fourth switch to turn on, and to control the fifth switch to turn off.

In some embodiment, the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the second set value is within the range of the third threshold; if the second set value is within the range of the third threshold, the second detection module outputs a logic control signal “0” to control the fourth switch to turn on, and to control the fifth switch to turn off; and if the second set value is outside the range of the third threshold, the second detection module outputs a logic control signal “1” to control the fifth switch to turn on, and to control the fourth switch to turn off.

In some embodiment, the first threshold is 20% of a rated current of the light emitting diode array.

In some embodiment, the range of the second threshold is ±2%.

In some embodiment, the range of the third threshold is ±2%.

The present disclosure also provides a light source driving method of a display panel, comprising: acquiring a load value for displaying a frame of an image, wherein the load value is a predetermined current value for driving a light emitting diode array of the display panel; determining whether the load value is greater than a first threshold, wherein the first threshold is 20% of a rated current of the light emitting diode array; controlling the light emitting diode array to be turned on and off based on a pulse width modulation signal if the load value is greater than the first threshold, such that an average current input to the light emitting diode array is the predetermined current value; and controlling the light emitting diode array to be turned on and off based on a pulse frequency modulation signal or a pulse skipping modulation signal if the load value is less than the first threshold, such that the average current input to the light emitting diode array is the predetermined current value.

In some embodiment, the display panel comprises a first switch, a second switch, a third switch, and a first detection module, the first switch is disposed in an output path of the pulse width modulation signal, the second switch is disposed in an output path of the pulse frequency modulation signal, the third switch is disposed in an output path of the pulse skipping modulation signal, and the first detection module is configured to acquire the load value and determine whether the load value is greater than the first threshold; if the predetermined current value is greater than the first threshold, the first detection module outputs a logic control signal “1” to control the first switch to turn on, and to control the second switch and the third switch to turn off; and if the predetermined current value is less than the first threshold, the first detection module outputs a logic control signal “0” to control the first switch to turn off, and to control the second switch and the third switch to turn on.

In some embodiment, if the load value is less than the first threshold, the light source driving method further comprises: acquiring a first set value corresponding to an output ripple; determining whether the first set value is within a range of a second threshold, wherein the range of the second threshold is ±2%; controlling the light emitting diode array to be turned on and off based on the pulse skipping modulation signal if the first set value is within the range of the second threshold; and controlling the light emitting diode array to be turned on and off based on the pulse frequency modulation signal if the first set value is outside the range of the second threshold.

In some embodiment, the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the first set value is within the range of the second threshold; if the first set value is within the range of the second threshold, the second detection module outputs a logic control signal “1” to control the fifth switch to turn on, and to control the fourth switch to turn off; and if the first set value is outside the range of the second threshold, the second detection module outputs a logic control signal “0” to control the fourth switch to turn on, and to control the fifth switch to turn off.

In some embodiment, if the load value is less than the first threshold, the light source driving method further comprises: acquiring a second set value corresponding to a voltage precision; determining whether the second set value is within a range of a third threshold, wherein the range of the third threshold is ±2%; controlling the light emitting diode array to be turned on and off based on the pulse frequency modulation signal if the second set value is within the range of the third threshold; and controlling the light emitting diode array to be turned on and off based on the pulse skipping modulation signal if the second set value is outside the range of the third threshold.

In some embodiment, the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the second set value is within the range of the third threshold; if the second set value is within the range of the third threshold, the second detection module outputs a logic control signal “0” to control the fourth switch to turn on, and to control the fifth switch to turn off; and if the second set value is outside the range of the third threshold, the second detection module outputs a logic control signal “1” to control the fifth switch to turn on, and to control the fourth switch to turn off.

The present disclosure also provides a light source driving circuit of a display panel, comprising: a modulation signal generating unit comprising a pulse width modulation signal generator, a pulse frequency modulation signal generator, and a pulse skipping modulation signal generator; an image detection module configured to acquire a load value of displaying a frame of an image, and determine whether the load value is greater than a first threshold, wherein the load value is a predetermined current value for driving a light emitting diode array of the display panel, and the first threshold is 20% of a rated current of the light emitting diode array; and a first path selector connected between the modulation signal generating unit and the image detection module; wherein the first path selector is configured to control the light emitting diode array to be turned on and off based on a pulse width modulation signal in response to the load value being greater than the first threshold, such that an average current input to the light emitting diode array is the predetermined current value; and wherein the first path selector is further configured to control the light emitting diode array to be turned on and off based on a pulse frequency modulation signal or a pulse skipping modulation signal in response to the load value being less than the first threshold, such that the average current input to the light emitting diode array is the predetermined current value.

In some embodiment, the first path selector comprises a first switch, a second switch, and a third switch, the first switch is disposed in an output path of the pulse width modulation signal generator, the second switch is disposed in an output path of the pulse frequency modulation signal generator, and the third switch is disposed in an output path of the pulse skipping modulation signal generator.

In some embodiment, the light source driving circuit further comprises a second path selector connected between the pulse frequency modulation signal generator and the pulse skipping modulation signal generator of the modulation signal generating unit and the image detection module, wherein the image detection module is further configured to acquire a first set value corresponding to an output ripple, and to determine whether the first set value is within a range of a second threshold, wherein the range of the second threshold is ±2%; wherein the second path selector is configured to control the light emitting diode array to be turned on and off based on the pulse skipping modulation signal in response to the first set value being within the range of the second threshold; and wherein the second path selector is further configured to control the light emitting diode array to be turned on and off based on the pulse frequency modulation signal in response to the first set value being outside the range of the second threshold.

In some embodiment, the second path selector comprises a fourth switch and a fifth switch, the fourth switch is disposed in an output path of the pulse frequency modulation signal generator, and the fifth switch is disposed in an output path of the pulse skipping modulation signal generator; in response to the first set value being within the range of the second threshold, the fifth switch is turned on, and the fourth switch is turned off; and in response to the first set value being outside the range of the second threshold, the fourth switch is turned on, and the fifth switch is turned off.

In some embodiment, the light source driving circuit further comprises a second path selector connected between the pulse frequency modulation signal generator and the pulse skipping modulation signal generator of the modulation signal generating unit and the image detection module, wherein the image detection module is configured to acquire a second set value corresponding to a voltage precision, and to determine whether the second set value is within a range of a third threshold, wherein the range of the third threshold is ±2%; wherein the second path selector is configured to control the light emitting diode array to be turned on and off based on the pulse frequency modulation signal in response to the second set value being within the range of the third threshold; and wherein the second path selector is further configured to control the light emitting diode array to be turned on and off based on the pulse skipping modulation signal in response to the second set value being outside the range of the third threshold.

In some embodiment, the second path selector comprises a fourth switch and a fifth switch, the fourth switch is disposed in an output path of the pulse frequency modulation signal generator, and the fifth switch is disposed in an output path of the pulse skipping modulation signal generator; in response to the second set value being within the range of the second threshold, the fourth switch is turned on, and the fifth switch is turned off; and in response to the second set value being outside the range of the second threshold, the fifth switch is turned on, and the fourth switch is turned off.

In comparison with the prior art, the present disclosure detects a gray scale or a voltage of the displayed image to determine the load for displaying the image. A modulation mode is determined by setting the thresholds and according to a size of the load. Under a high load, a pulse width modulation mode is selected. In addition, under a low load, according to the efficiency and ripple requirements of the circuit, one of a pulse frequency modulation mode and a pulse skipping modulation mode is selected. With this design, the present disclosure realizes a circuit structure for multi-modulation conversion.

### BRIEF DESCRIPTION OF DRAWINGS

The following describes specific embodiments of the present disclosure in detail with reference to accompanying drawings to make technical solutions and other beneficial effects of the present disclosure obvious.

FIG. 1 shows a schematic diagram of a light source driving circuit of a display panel according to an embodiment of the present disclosure.

FIG. 2 shows a flowchart of a light source driving method of a display panel according to a first embodiment of the present disclosure.

FIG. 3 shows a flowchart of a light source driving method of a display panel according to a second embodiment of the present disclosure.

### DETAILED DESCRIPTION

The technical solutions in the embodiments of the present disclosure will be clearly and completely described below in conjunction with the drawings in the embodiments of the present disclosure. Apparently, the described embodiments are only a part of the embodiments of the present disclosure, but not all of the embodiments. Based on the embodiments in the present disclosure, all other embodiments obtained by those skilled in the art without creative efforts shall fall within the scope of protection of the present disclosure.

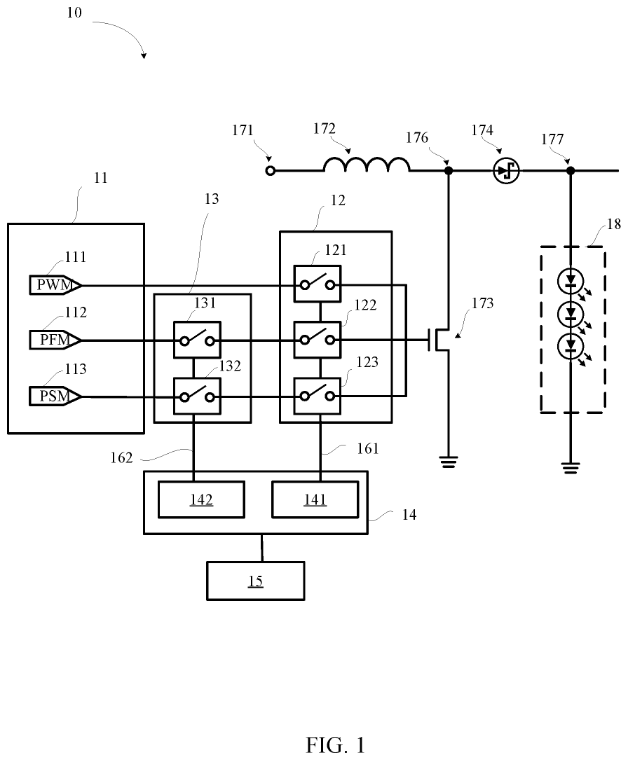

Referring to FIG. 1, which shows a schematic diagram of a light source driving circuit 10 of a display panel according to an embodiment of the present disclosure. The light source driving circuit 10 includes a modulation signal generating unit 11, a first path selector 12, a second path selector 13, an image detection module 14, a memory 15, a current input terminal 171, an inductor 172, a transistor 173, and a diode 174. A first terminal of the inductor 172 is connected to the current input terminal 171, and a second terminal of the inductor 172 is connected to a first node 176. A gate of the transistor 173 is connected to the modulation signal generating unit 11 through the first path selector 12 and the second path selector 13. One of a source or a drain of the transistor 173 is connected to the first node 176, and the other of the source or the drain of the transistor 173 is grounded. An anode of the diode 174 is connected to the first node 176 and a cathode of the diode 174 is connected to a second node 177. The display panel includes a light emitting diode array 18, and one end of the light emitting diode array 18 is connected to the second node 177.

As shown in FIG. 1, the current input terminal 171 is configured to input a current for driving the light emitting diode array 18 to emit light. For example, the current input terminal 171 can be connected to a power controller, and an external power source can be converted into direct current through the power controller.

As shown in FIG. 1, the modulation signal generating unit 11 includes a pulse width modulation signal generator 111, a pulse frequency modulation (PFM) signal generator 112, and a pulse skipping modulation (PSM) signal generator 113. The pulse width modulation signal generator 111 is configured to generate a pulse width modulation signal. The pulse frequency modulation signal generator 112 is configured to generate a pulse frequency modulation signal. The pulse skipping modulation signal generator 113 is configured to generate a pulse skipping modulation signal. The signal generated by the modulation signal generating unit 11 is a square wave signal. The square wave signal is input to the gate of the transistor 173. When the square wave signal is at a high level, no current flows through the light emitting diode array 18. When the square wave signal is at a low level, the light emitting diode array 18 has current flowing through it. Furthermore, by changing a duty cycle of the square wave signal output by the modulation signal generating unit 11, an average current input to the light emitting diode array 18 can be adjusted correspondingly.

Taking inputting the pulse width modulation signal as an example, a principle is to control length of time on and length of time off (i.e., a pulse width) of the transistor 173 with a fixed DC voltage/current and frequency, thereby controlling the average current input to the light emitting diode array 18. When the light emitting diode array 18 is turned on, a maximum current (e.g., a rated current) is Imax, a period of turning-on and turning-off of the transistor 173 is T, and each closing time is t, then a duty cycle is D=t/T. The average current of the light emitting diode array 18 is the turning period multiplied by the maximum current, that is, Iavg=D×Imax.

Secondly, taking inputting the pulse frequency modulation signal as an example, a principle is to control a frequency of turning-on and turning-off of the transistor 173 with a fixed DC voltage/current and a fixed pulse width, thereby controlling the average current input to the light emitting diode array 18. Similarly, the average current of the light emitting diode array 18 is determined by the turning-on time, the frequency, and the maximum current value.

Furthermore, taking inputting the pulse skipping modulation signal as an example, a principle is to drive with a fixed DC voltage/current, frequency, and pulse width. However, under a light load, the pulse skipping modulation signal will skip some switching cycles. During the skipped period, the transistor 173 remains in an off state, thereby controlling the average current input to the light emitting diode array 18. Similarly, the average current of the light emitting diode array 18 is determined by the turning-on time, the frequency, and the maximum current value.

The larger the average current input to the light emitting diode array 18 is, the higher the luminous intensity of the light emitting diode array 18 is. Conversely, the smaller the current value, the lower the luminous intensity of the light emitting diode array 18. Based on a fact that human eyes are not sensitive enough to brightness flicker, the current input to the light emitting diode array 18 is adjusted by the signal of the modulation signal generating unit 11 to make the light emitting diode array 18 bright and dark. Therefore, the brightness of the light emitting diode array 18 can be adjusted by adjusting a ratio of light and dark time. As shown in FIG. 1, the pulse width modulation signal generator 111, the pulse frequency modulation signal generator 112, and the pulse skipping modulation signal generator 113 of the modulation signal generating unit 11 are connected to the gate of the transistor 173 through the first path selector 12. The pulse frequency modulation signal generator 112 and the pulse skipping modulation signal generator 113 of the modulation signal generating unit 11 are connected to the first path selector 12 through the second path selector 13. In this embodiment, the signal input to the gate of the transistor 173 is controlled by the first path selector 12 and the second path selector 13. The specific path selection method will be detailed later.

As shown in FIG. 1, the memory 15 is configured to store data for displaying at least a frame of an image, a first set value corresponding to an output ripple, a second set value corresponding to a voltage precision, and so on. The data for displaying at least a frame of an image includes grayscale values of pixels, driving voltage values, and so on.

As shown in FIG. 1, the image detection module 14 includes a first detection module 141 and a second detection module 142. The first detection module 141 is configured to acquire the grayscale values or the driving voltage values of the pixels in the memory 15, and calculate the load value for displaying the frame of the image according to the grayscale values or the driving voltage values of the pixels, that is, the predetermined current value for driving the light emitting diode array 18. For example, the gray scale values of the pixels in the image corresponds to a specific brightness level of the light emitting diode array 18, and the predetermined current value for driving the light emitting diode array 18 can be calculated according to the brightness level. The average current of the light emitting diode array 18 adjusted by the modulation signal is the predetermined current value required to drive it.

The first detection module 141 determines whether the load value is greater than the first threshold. For example, the load current for displaying the frame of the image can be calculated according to the gray scale values or the driving voltage values of the pixels, and the first threshold can be N % of the rated current, such as 20%. When the load current of the display panel is greater than the first threshold, it is determined that the display panel has a high load. When the load current of the display panel is lower than the first threshold, it is determined that the display panel has a low load. It should be noted that, depending on products, the first threshold can be set differently. Taking a product with a size of 65 inches and 4K image quality as an example, when the grayscale values are above 180-grayscale, the display panel can be considered as in the high load.

As shown in FIG. 1, the second detection module 142 is configured to acquire the first set value corresponding to the output ripple or the second set value corresponding to the voltage precision. The second detection module 142 determines whether the first set value is less than the second threshold, or whether the second set value is less than the third threshold. The light emitting diode emits light passively, and the driving current will affect a stability of the luminous brightness of the light-emitting diode. In the PSM and PFM modes, the pulse width is constant, but the ripple will slightly change the constant pulse width. For example, when the frequency increases, the maximum current and pulse width will slightly change between different frequencies to provide a more continuous power increase, so a constant pulse width will have a small change (i.e., the ripple), such as 1% or 5%. The lower the output ripple of the drive current, the more stable the luminous brightness of the light-emitting diode. If the ripple of the driving current of the light emitting diode array 18 is too large, it will cause the display panel to flicker. In some embodiments, when the required output ripple is less than ±2% (i.e., the second threshold), it is regarded as a higher required output ripple. Similarly, the voltage precision will also affect the display quality of the display panel. In some embodiments, when the required voltage precision is less than ±2% (i.e., the third threshold), it is regarded as a higher required voltage precision. It should be understood that the first set value of the output ripple and the second set value of the voltage precision can be set according to external hardware (such as, a resistor string), or can be set through software instructions in a timing controller.

As shown in FIG. 1, the first path selector 12 is connected between the modulation signal generating unit 11 and the image detection module 14, and the first path selector 12 is connected to the first detection module 141 of the image detection module 14 through a first control line 161. According to the determining result of the first detection module 141, the first path selector 12 is determined to adjust the current value input to the light emitting diode array 18 of the display panel based on the signal generated by one of the pulse width modulation signal generator 111, the pulse frequency modulation signal generator 112, and the pulse skipping modulation signal generator 113. Specifically, the first path selector 12 includes a first switch 121, a second switch 122, and a third switch 123. The first switch 121 is disposed in an output path of the pulse width modulation signal generator 111. The second switch 122 is disposed in an output path of the pulse frequency modulation signal generator 112. The third switch 123 is disposed in an output path of the pulse skipping modulation signal generator 113.

If the determining result of the first detection module 141 is that the load value is greater than the first threshold, the first detection module 141 outputs a logic control signal “1”. At this time, the first switch 121 is turned on (ON), and the second switch 122 and third switch 123 are turned off (OFF). Therefore, the current value of the light emitting diode array 18 input to the display panel is adjusted based on the width modulation signal. Specifically, the light emitting diode array 18 is controlled to be turned on and off based on the pulse width modulation signal, so that the average current input to the light emitting diode array 18 is the predetermined current value. Under the high load, by using the width modulation mode, it can work at a fixed higher frequency and maintain lower output voltage ripple, and also has advantages of high linearity and high efficiency.

On the other hand, if the determining result of the first detection module 141 is that the load value is less than the first threshold, the first detection module 141 outputs a logic control signal “0”. At this time, the first switch 121 is turned off, and the second switch 122 and third switch 123 are turned on. Thus, the current value input to the light emitting diode array 18 of the display panel is adjusted based on one of the pulse frequency modulation signal or the pulse skipping modulation signal. Specifically, the light emitting diode array 18 is controlled to be turned on and off based on the pulse frequency modulation signal or the pulse skipping modulation signal, so that the average current input to the light emitting diode array 18 is the predetermined current value. As the load becomes lighter, the work efficiency of the width modulation mode decreases. Therefore, in the present disclosure, the pulse frequency modulation mode or the pulse skipping modulation mode is adopted under light load conditions.

As shown in FIG. 1, the second path selector 13 is connected between the pulse frequency modulation signal generator 112 and the pulse skipping modulation signal generator 113 of the modulation signal generating unit 11 and the image detection module 14. The second path selector 13 is connected to the second detection module 142 of the image detection module 14 through a second control line 162. In a case of the low load, according to the determining result of the second detection module 142, the second path selector 13 is determined to adjust the current value of the light emitting diode array 18 input to the display panel based on the signal generated by one of the pulse frequency modulation signal generator 112 and the pulse skipping modulation signal generator 113. Specifically, the second path selector 13 includes a fourth switch 131 and a fifth switch 132. The fourth switch 131 is dispsoed in an output path of the pulse frequency modulation signal generator 112. The fifth switch 132 is dispsoed in an output path of the pulse skipping modulation signal generator 113.

In some embodiments, if the determining result of the second detection module 142 is that the first set value of the output ripple is less than the second threshold, the second detection module 142 outputs a logic control signal “1”. At this time, the fifth switch 132 is turned on and the fourth switch 131 is turned off. Therefore, under low load conditions, the current value of the light emitting diode array 18 input to the display panel is adjusted based on the pulse skipping modulation signal. Specifically, the light emitting diode array 18 is controlled to be turned on and off based on the pulse skipping modulation signal, so that the average current input to the light emitting diode array 18 is the predetermined current value.

On the other hand, if the determining result of the second detection module 142 is that the first set value of the output ripple is greater than the second threshold, the first detection module 141 outputs a logic control signal “0”. At this time, the fifth switch 132 is turned off and the fourth switch 131 is turned on. Therefore, under low load conditions, the current value of the light emitting diode array 18 input to the display panel is adjusted based on the pulse frequency modulation signal. Specifically, the light emitting diode array 18 is controlled to be turned on and off based on the pulse frequency modulation signal, so that the average current input to the light emitting diode array 18 is the predetermined current value.

In the pulse frequency modulation mode, the frequency of the output ripple is relatively dispersed, which makes it difficult to filter the wave. In contrast, the pulse skipping modulation mode not only has a higher conversion efficiency under light load conditions, but its output ripple is less dispersed than the output ripple of the pulse frequency modulation mode. In addition, in the case of the light load, the pulse skipping modulation mode has an advantage of high efficiency, and its switching loss is proportional to an output power of a system, and the correlation with the load is low.

In some embodiments, if the determining result of the second detection module 142 is that the second set value of the voltage precision is less than the third threshold, the second detection module 142 outputs the logic control signal “0”. At this time, the fifth switch 132 is turned off and the fourth switch 131 is turned on. Therefore, under low load conditions, the current value of the light emitting diode array 18 input to the display panel is adjusted based on the pulse frequency modulation signal. Specifically, the light emitting diode array 18 is controlled to be turned on and off based on the pulse frequency modulation signal, so that the average current input to the light emitting diode array 18 is the predetermined current value.

On the other hand, if the determining result of the second detection module 142 is that the first set value of the output ripple is greater than the second threshold, the second detection module 142 outputs the logic control signal “1”. At this time, the fifth switch 132 is turned on and the fourth switch 131 is turned off. Therefore, under low load conditions, the current value of the light emitting diode array 18 input to the display panel is adjusted based on the pulse skipping modulation signal. Specifically, the light emitting diode array 18 is controlled to be turned on and off based on the pulse skipping modulation signal, so that the average current input to the light emitting diode array 18 is the predetermined current value.

In the pulse skipping modulation mode, the output voltage has a large ripple voltage, which is not suitable for a system that require high power supply voltage precision. In contrast, under light load conditions, the pulse frequency modulation mode has advantages of high efficiency and excellent frequency characteristics.

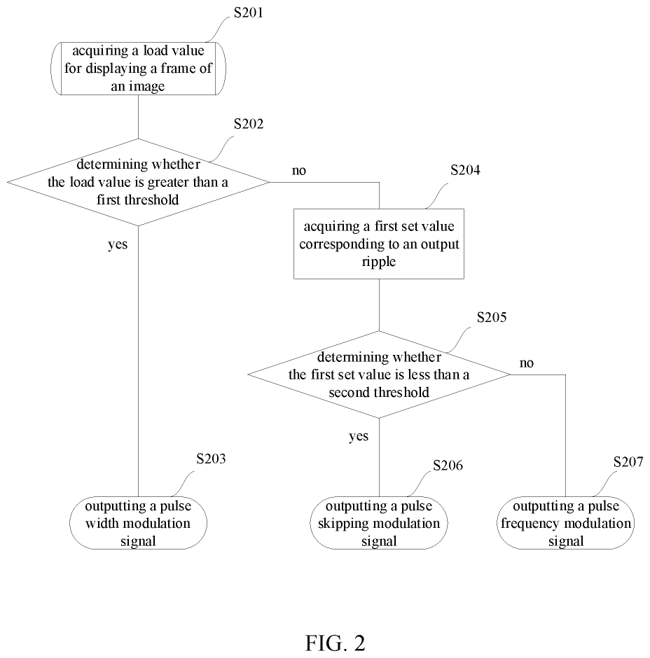

Referring to FIG. 2, which shows a flowchart of a light source driving method of a display panel according to a first embodiment of the present disclosure. In this embodiment, the light source driving method is performed by the light source driving circuit 10 described above. The light source driving method includes steps S201 to S207.

In a step S201, a load value for displaying a frame of an image is acquired. Specifically, the first detection module 141 of the image detection module 14 acquires the grayscale values or driving voltage values of the pixels in the memory 15, and calculates the load value for displaying the frame of the image according to the grayscale values or driving voltage values of the pixels, that is the predetermined current value for driving the light emitting diode array 18. For example, the gray scale value of the pixel in the image corresponds to a specific brightness level of the light emitting diode array 18, and the predetermined current value for driving the light emitting diode array 18 can be calculated according to the brightness level. The average current of the light emitting diode array 18 adjusted by the modulation signal is the predetermined current value required to drive it.

In a step S202, it is determined whether the load value is greater than a first threshold. Specifically, the first detection module 141 determines whether the load value is greater than the first threshold. The first threshold can be N % of a rated current, such as 20%. If the load current of the display panel is greater than the first threshold, it is determined that the display panel has a high load, and a step S203 is performed. If the load current of the display panel is lower than the first threshold, it is determined that the display panel has a low load, and a step S204 is performed.

In the step S203, the pulse width modulation signal is output. Specifically, according to the determining result, it is determined to adjust the current value of the light emitting diode array input to the display panel based on the pulse width modulation signal. Specifically, if the determining result of the first detection module 141 is that the load value is greater than the first threshold, the first detection module 141 outputs a logic control signal “1”. At this time, the first switch 121 is turned on, and the second switch 122 and the third switch 123 are turned off. Therefore, the current value of the light emitting diode array 18 input to the display panel is adjusted based on the pulse width modulation signal. Specifically, the light emitting diode array 18 is controlled to be turned on and off based on the pulse width modulation signal, so that the average current input to the light emitting diode array 18 is the predetermined current value. Under the high load, by using pulse width modulation mode, it can work at a fixed higher frequency and maintain lower output voltage ripple, and also has advantages of high linearity and high efficiency.

In the step S204, a first set value corresponding an output ripple is acquired. If the determining result of the first detection module 141 is that the load value is less than the first threshold, the first detection module 141 outputs the logic control signal “0”. At this time, the first switch 121 is turned off, and the second switch 122 and third switch 123 are turned on. Therefore, the current value input to the light emitting diode array 18 of the display panel is adjusted based on one of the pulse frequency modulation signal or the pulse skipping modulation signal. Specifically, the light emitting diode array 18 is controlled to be turned on and off based on the pulse frequency modulation signal or the pulse skipping modulation signal, so that the average current input to the light emitting diode array 18 is the predetermined current value. At this time, the second detection module 142 of the image detection module 14 acquires the first set value of the output ripple in the memory 15.

In a step S205, it is determined whether the first set value is less than a second threshold. In some embodiments, when the required output ripple is less than ±2% (i.e., the second threshold), it is regarded as a higher required output ripple. When the determining result of the second detection module 142 is that the first set value of the output ripple is less than the second threshold, the second detection module 142 outputs a logic control signal “1”. At this time, the fifth switch 132 is turned on and the fourth switch 131 is turned off, and a step S206 is performed. Specifically, the light emitting diode array 18 is controlled to be turned on and off based on the pulse frequency modulation signal or the pulse skipping modulation signal, so that the average current input to the light emitting diode array 18 is the predetermined current value. On the other hand, when the determining result of the second detection module 142 is that the first set value of the output ripple is greater than the second threshold, the second detection module 142 outputs the logic control signal “0”. At this time, the fifth switch 132 is turned off and the fourth switch 131 is turned on, and a step S207 is performed.

In the step S206, the pulse skipping modulation signal is output. Specifically, according to the determining result, it is determined to adjust the current value of the light emitting diode array input to the display panel based on the pulse skipping modulation signal. Specifically, the light emitting diode array 18 is controlled to be turned on and off based on the pulse skipping modulation signal, so that the average current input to the light emitting diode array 18 is the predetermined current value. In the pulse frequency modulation mode, the frequency of the output ripple is relatively scattered, which makes it difficult to filter the wave. In contrast, the pulse skipping modulation mode not only has a higher conversion efficiency under light load conditions, but its output ripple is less dispersed than the output ripple of the pulse frequency modulation mode. In addition, in the case of the light load, the pulse skipping modulation mode has an advantage of high efficiency, and its switching loss is proportional to an output power of a system, and the correlation with the load is low.

In the step S207, the pulse frequency modulation signal is output. Specifically, according to the determining result, it is determined to adjust the current value of the light emitting diode array input to the display panel based on the pulse frequency modulation signal. Specifically, the light emitting diode array 18 is controlled to be turned on and off based on the pulse frequency modulation signal, so that the average current input to the light emitting diode array 18 is the predetermined current value.

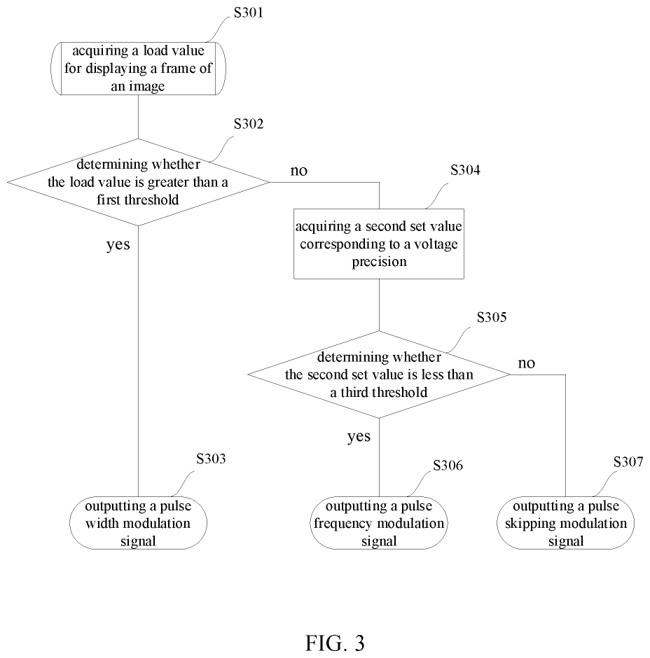

Referring to FIG. 3, which shows a flowchart of a light source driving method of a display panel according to a second embodiment of the present disclosure. In this embodiment, the light source driving method is performed by the light source driving circuit 10 described above. The light source driving method includes steps S301 to S307, and steps S301 to S303 of the second embodiment are similar to the steps S201 to S203 of the first embodiment, and will not be repeated here.

If the determining result of the first detection module 141 is that the load value is less than the first threshold, the first detection module 141 outputs the logic control signal “0”. At this time, the first switch 121 is turned off, and the second switch 122 and the third switch 123 are turned on. Therefore, the current value input to the light emitting diode array 18 of the display panel is adjusted based on one of the pulse frequency modulation signal or the pulse skipping modulation signal. At this time, in a step S304, a second set value corresponding to the voltage precision is acquired. The second detection module 142 of the image detection module 14 acquires the second set value corresponding to the voltage precision in the memory 15.

In a step S305, it is determined whether the second set value is less than a third threshold. In some embodiments, if the required voltage precision is less than ±2% (i.e., the third threshold), it is regarded as a higher required voltage precision. If the determining result of the second detection module 142 is that the second set value of voltage precision is less than the third threshold, the first detection module 141 outputs the logic control signal “0”. At this time, the fifth switch 132 is turned off and the fourth switch 131 is turned on, and a step S306 is performed. On the other hand, if the determining result of the second detection module 142 is that the second set value of the voltage precision is greater than the third threshold, the second detection module 142 outputs a logic control signal “1”. At this time, the fifth switch 132 is turned on and the fourth switch 131 is turned off, and a step S307 is performed.

In the step S306, the pulse frequency modulation signal is output. Specifically, according to the determining result, it is determined to adjust the current value of the light emitting diode array input to the display panel based on the pulse frequency modulation signal. Specifically, the light emitting diode array 18 is controlled to be turned on and off based on the pulse frequency modulation signal, so that the average current input to the light emitting diode array 18 is the predetermined current value. In the pulse skipping modulation mode, the output voltage has a large ripple voltage, which is not suitable for a system that require high power supply voltage precision. In contrast, under light load conditions, the pulse frequency modulation mode has advantages of high efficiency and excellent frequency characteristics.

In the step S307, the pulse skipping modulation signal is output. Specifically, according to the determining result, it is determined to adjust the current value of the light emitting diode array input to the display panel based on the pulse skipping modulation signal. Specifically, the light emitting diode array 18 is controlled to be turned on and off based on the pulse skipping modulation signal, so that the average current input to the light emitting diode array 18 is the predetermined current value.

In summary, the present disclosure detects the gray scale or the voltage of the displayed image to determine the load for displaying the image. The modulation mode is determined by setting the thresholds and according to a size of the load. Under the high load, the pulse width modulation mode is selected. In addition, under the low load, according to the efficiency and ripple requirements of the circuit, one of the pulse frequency modulation mode and the pulse skipping modulation mode is selected. With this design, the present disclosure realizes a circuit structure for multi-modulation conversion.

The light source driving circuit and the light source driving method of the display panel of the embodiments of the present disclosure are described in detail above. Specific examples are used in this specification to illustrate the principle and implementations of the present disclosure. The description of the above embodiments is only used to help understand the technical solutions of the present disclosure and its core idea. Those of ordinary skill in the art should understand that they can still modify the technical solutions described in the foregoing embodiments, or equivalently replace some of the technical features. However, these modifications or replacements do not cause the essence of the corresponding technical solutions to deviate from the scope of the technical solutions of the embodiments of the present disclosure.

What is claimed is:

1. A light source driving method of a display panel, comprising:
acquiring a load value for displaying a frame of an image, wherein the load value is a predetermined current value for driving a light emitting diode array of the display panel;
determining whether the load value is greater than a first threshold;
controlling the light emitting diode array to be turned on and off based on a pulse width modulation signal if the load value is greater than the first threshold, such that an average current input to the light emitting diode array is the predetermined current value; and
controlling the light emitting diode array to be turned on and off based on a pulse frequency modulation signal or a pulse skipping modulation signal if the load value is less than the first threshold, such that the average current input to the light emitting diode array is the predetermined current value;
wherein the light source driving method further comprises:
acquiring a first set value corresponding to an output ripple, and determining whether the first set value is within a range of a second threshold if the load value is less than the first threshold value, wherein if the first set value is within the range of the second threshold, the light emitting diode array is controlled to be turned on and off based on the pulse skipping modulation signal, and if the first set value is outside the range of the second threshold, the light emitting diode array is controlled to be turned on and off based on the pulse frequency modulation signal; or
acquiring a second set value corresponding to a voltage precision, and determining whether the second set value is within a range of a third threshold if the load value is less than the first threshold, wherein if the second set value is within the range of the third threshold, the light emitting diode array is controlled to be turned on and off based on the pulse frequency modulation signal, and if the second set value is outside the range of the third threshold, the light emitting diode array is controlled to be turned on and off based on the pulse skipping modulation signal.

2. The light source driving method of the display panel according to claim 1, wherein the display panel comprises a first switch, a second switch, a third switch, and a first detection module, the first switch is disposed in an output path of the pulse width modulation signal, the second switch is disposed in an output path of the pulse frequency modulation signal, the third switch is disposed in an output path of the pulse skipping modulation signal, and the first detection module is configured to acquire the load value and determine whether the load value is greater than the first threshold;
if the predetermined current value is greater than the first threshold, the first detection module outputs a logic control signal “1” to control the first switch to turn on, and to control the second switch and the third switch to turn off; and
if the predetermined current value is less than the first threshold, the first detection module outputs a logic control signal “0” to control the first switch to turn off, and to control the second switch and the third switch to turn on.

3. The light source driving method of the display panel according to claim 1, wherein the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the first set value is within the range of the second threshold;
if the first set value is within the range of the second threshold, the second detection module outputs a logic control signal “1” to control the fifth switch to turn on, and to control the fourth switch to turn off; and
if the first set value is outside the range of the second threshold, the second detection module outputs a logic control signal “0” to control the fourth switch to turn on, and to control the fifth switch to turn off.

4. The light source driving method of the display panel according to claim 1, wherein the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the second set value is within the range of the third threshold;
if the second set value is within the range of the third threshold, the second detection module outputs a logic control signal “0” to control the fourth switch to turn on, and to control the fifth switch to turn off; and
if the second set value is outside the range of the third threshold, the second detection module outputs a logic control signal “1” to control the fifth switch to turn on, and to control the fourth switch to turn off.

5. The light source driving method of the display panel according to claim 1, wherein the first threshold is 20% of a rated current of the light emitting diode array.

6. The light source driving method of the display panel according to claim 1, wherein the range of the second threshold is ±2%.

7. The light source driving method of the display panel according to claim 1, wherein the range of the third threshold is ±2%.

8. A light source driving method of a display panel, comprising:
acquiring a load value for displaying a frame of an image, wherein the load value is a predetermined current value for driving a light emitting diode array of the display panel;
determining whether the load value is greater than a first threshold, wherein the first threshold is 20% of a rated current of the light emitting diode array;
controlling the light emitting diode array to be turned on and off based on a pulse width modulation signal if the load value is greater than the first threshold, such that an average current input to the light emitting diode array is the predetermined current value; and
controlling the light emitting diode array to be turned on and off based on a pulse frequency modulation signal or a pulse skipping modulation signal if the load value is less than the first threshold, such that the average current input to the light emitting diode array is the predetermined current value.

9. The light source driving method of the display panel according to claim 8, wherein the display panel comprises a first switch, a second switch, a third switch, and a first detection module,
the first switch is disposed in an output path of the pulse width modulation signal, the second switch is disposed in an output path of the pulse frequency modulation signal, the third switch is disposed in an output path of the pulse skipping modulation signal, and the first detection module is configured to acquire the load value and determine whether the load value is greater than the first threshold;
if the predetermined current value is greater than the first threshold, the first detection module outputs a logic control signal “1” to control the first switch to turn on, and to control the second switch and the third switch to turn off; and
if the predetermined current value is less than the first threshold, the first detection module outputs a logic control signal “0” to control the first switch to turn off, and to control the second switch and the third switch to turn on.

10. The light source driving method of the display panel according to claim 8, wherein if the load value is less than the first threshold, the light source driving method further comprises:
acquiring a first set value corresponding to an output ripple;
determining whether the first set value is within a range of a second threshold, wherein the range of the second threshold is ±2%;
controlling the light emitting diode array to be turned on and off based on the pulse skipping modulation signal if the first set value is within the range of the second threshold; and
controlling the light emitting diode array to be turned on and off based on the pulse frequency modulation signal if the first set value is outside the range of the second threshold.

11. The light source driving method of the display panel according to claim 10, wherein the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the first set value is within the range of the second threshold;
if the first set value is within the range of the second threshold, the second detection module outputs a logic control signal “1” to control the fifth switch to turn on, and to control the fourth switch to turn off; and
if the first set value is outside the range of the second threshold, the second detection module outputs a logic control signal “0” to control the fourth switch to turn on, and to control the fifth switch to turn off.

12. The light source driving method of the display panel according to claim 8, wherein if the load value is less than the first threshold, the light source driving method further comprises:
acquiring a second set value corresponding to a voltage precision;
determining whether the second set value is within a range of a third threshold, wherein the range of the third threshold is ±2%;
controlling the light emitting diode array to be turned on and off based on the pulse frequency modulation signal if the second set value is within the range of the third threshold; and
controlling the light emitting diode array to be turned on and off based on the pulse skipping modulation signal if the second set value is outside the range of the third threshold.

13. The light source driving method of the display panel according to claim 12, wherein the display panel comprises a fourth switch, a fifth switch, and a second detection module, the fourth switch is disposed in an output path of the pulse frequency modulation signal, the fifth switch is disposed in an output path of the pulse skipping modulation signal, and the second detection module is configured to acquire the second threshold and determine whether the second set value is within the range of the third threshold;
if the second set value is within the range of the third threshold, the second detection module outputs a logic control signal “0” to control the fourth switch to turn on, and to control the fifth switch to turn off; and
if the second set value is outside the range of the third threshold, the second detection module outputs a logic control signal “1” to control the fifth switch to turn on, and to control the fourth switch to turn off.

14. A light source driving circuit of a display panel, comprising:
a modulation signal generating unit comprising a pulse width modulation signal generator, a pulse frequency modulation signal generator, and a pulse skipping modulation signal generator;
an image detection module configured to acquire a load value of displaying a frame of an image, and determine whether the load value is greater than a first threshold, wherein the load value is a predetermined current value for driving a light emitting diode array of the display panel, and the first threshold is 20% of a rated current of the light emitting diode array; and
a first path selector connected between the modulation signal generating unit and the image detection module;
wherein the first path selector is configured to control the light emitting diode array to be turned on and off based on a pulse width modulation signal in response to the load value being greater than the first threshold, such that an average current input to the light emitting diode array is the predetermined current value; and
wherein the first path selector is further configured to control the light emitting diode array to be turned on and off based on a pulse frequency modulation signal or a pulse skipping modulation signal in response to the load value being less than the first threshold, such that the average current input to the light emitting diode array is the predetermined current value.

15. The light source driving circuit of the display panel according to claim 14, wherein the first path selector comprises a first switch, a second switch, and a third switch, the first switch is disposed in an output path of the pulse width modulation signal generator, the second switch is disposed in an output path of the pulse frequency modulation signal generator, and the third switch is disposed in an output path of the pulse skipping modulation signal generator.

16. The light source driving circuit of the display panel according to claim 14, wherein the light source driving circuit further comprises a second path selector connected between the pulse frequency modulation signal generator and the pulse skipping modulation signal generator of the modulation signal generating unit and the image detection module, wherein the image detection module is further configured to acquire a first set value corresponding to an output ripple, and to determine whether the first set value is within a range of a second threshold, wherein the range of the second threshold is ±2%;
wherein the second path selector is configured to control the light emitting diode array to be turned on and off based on the pulse skipping modulation signal in response to the first set value being within the range of the second threshold; and
wherein the second path selector is further configured to control the light emitting diode array to be turned on and off based on the pulse frequency modulation signal in response to the first set value being outside the range of the second threshold.

17. The light source driving circuit of the display panel according to claim 16, wherein the second path selector comprises a fourth switch and a fifth switch, the fourth switch is disposed in an output path of the pulse frequency modulation signal generator, and the fifth switch is disposed in an output path of the pulse skipping modulation signal generator;
in response to the first set value being within the range of the second threshold, the fifth switch is turned on, and the fourth switch is turned off; and
in response to the first set value being outside the range of the second threshold, the fourth switch is turned on, and the fifth switch is turned off.

18. The light source driving circuit of the display panel according to claim 14, wherein the light source driving circuit further comprises a second path selector connected between the pulse frequency modulation signal generator and the pulse skipping modulation signal generator of the modulation signal generating unit and the image detection module, wherein the image detection module is configured to acquire a second set value corresponding to a voltage precision, and to determine whether the second set value is within a range of a third threshold, wherein the range of the third threshold is ±2%;
wherein the second path selector is configured to control the light emitting diode array to be turned on and off based on the pulse frequency modulation signal in response to the second set value being within the range of the third threshold; and
wherein the second path selector is further configured to control the light emitting diode array to be turned on and off based on the pulse skipping modulation signal in response to the second set value being outside the range of the third threshold.

19. The light source driving circuit of the display panel according to claim 18, wherein the second path selector comprises a fourth switch and a fifth switch, the fourth switch is disposed in an output path of the pulse frequency modulation signal generator, and the fifth switch is disposed in an output path of the pulse skipping modulation signal generator;
in response to the second set value being within the range of the second threshold, the fourth switch is turned on, and the fifth switch is turned off; and
in response to the second set value being outside the range of the second threshold, the fifth switch is turned on, and the fourth switch is turned off.
